(19) United States
(12) Patent Application Publication
(10) Pub. No.: US 2002/0056590 A1
(43) Pub. Date: May 16, 2002

(54) Safety apparatus

(75) Inventors: James Donald Goldie, Scawsby (GB); David Buxton, Sprotbrough (GB); Michael Holland, Doncaster (GB)

Correspondence Address: BROWDY AND NEIMARK, P.L.L.C., 624 NINTH STREET, NW, SUITE 300, WASHINGTON, DC, 20001-5303, US

(73) Assignee: CEMENTATION FOUNDATIONS SKANSKA LIMITED Rickmansworth, United Kingdom

(21) Appl. No.: 09/987,454

(22) Filed: Nov. 14, 2001

(30) Foreign Application Priority Data
Nov. 14, 2000 (GB) 0027777.2

(51) Int. Cl. A62B 35/04

(52) U.S. Cl. 182/36; 182/113

(57) ABSTRACT

The present application relates to a safety apparatus which is intended to aid the balance of an individual working on an elevated surface such as a horizontal mast 1. The apparatus, which consists of a support member 5 that projects up from the elevated surface, may also arrest the fall of an individual from an elevated surface by defining a support barrier in front or behind or either side of the individual. The support member may be adapted to be mounted within tool tracks already provided on a mast, and is designed to move along the tracks so as to balance the individual as he moves along the elevated surface. Alternatively, the elevated surface is provided with additional purpose-built guides or tracks designed to cooperate with the support member.

The present invention relates to a safety apparatus for aiding the balance of a worker on an elevated surface. More particularly, the present invention relates to a safety apparatus for use on a horizontal mast.

During piling operations, an underground structure such as a foundation element, is formed by constructing a series of piles in the ground and then filling the holes with concrete or grout. A piling rig allows a hole forming tool to be suspended above the ground from a mast and the tool is then caused to penetrate the ground to a predetermined distance. There are a number of stages in the operation, such as during the preparation of the rig for transport or during the erection of the mast, when the mast is horizontal and it is common for personnel to climb up and onto the horizontal mast to facilitate the maintenance and assembly of the rig. Furthermore, some multi-purpose rigs require a significant amount of mast mounted work to change the mode of operation.

The safety of the worker on the mast, particularly where the height of the mast above the ground is greater than recommended safety heights, is therefore a concern. Furthermore, in the event of strong winds there is a significant risk of a worker falling from the elevated horizontal mast. It is therefore desirable to provide a safety apparatus which helps the worker to balance or even, to arrest the fall of personnel working on an elevated surface such as a horizontal mast.

Several safety systems are known in which an anchorage point for a safety harness is provided above or beside the elevated surface. The anchorage point may be used in conjunction with a safety handle and may be arranged to move on a track or the like attached to a surface adjacent or above the elevated surface.

However, personnel working on an elevated surface such as a horizontal mast, cannot easily be provided with a safety line since there is no suitable anchorage point in close proximity. Several devices are known already which can be clamped to the top surface of a structure. For example, a clamping apparatus is known in which two slidable elongate members cooperate to form a beam of variable length spanning the structure on which the worker is positioned. The members extend over the sides of the structure and are resiliently bias towards each other so that they grip the structure. This therefore provides an anchorage point from which a safety line and harness can be attached.

This device however, can be both time consuming to secure in place and, due to the dimensions of the mast on a piling rig (approx. 30 m long and 0.6 m wide), is not suitable for use during site operations.

According to one aspect of the present invention there is provided a safety apparatus for supporting an individual on an elevated surface or arresting the fall of an individual from an elevated surface, comprising i) a support member which is mounted to the elevated surface ii) a means to facilitate the motion of the support member along said elevated surface.

It is common for masts to be provided with tracks which run along the length, or a part of the length, of the mast. These tracks enable tools such as a rotary head or hammer to travel along the horizontal mast.

The safety apparatus of the present invention may advantageously be adapted to be mounted within the tool tracks already provided on the mast. Furthermore, runners or wheels are advantageously provided which allow the member to travel along the mast-tracks, thereby providing a support to help balance a worker as he moves along on the top of the mast. Alternatively, the elevated surface is provided with additional purpose-built guides or tracks designed to cooperate with the support member.

Preferably, the support member is in the form of a frame comprising two pairs of legs, each pair of legs defining a side of the frame. Each leg is provided at the base thereof with a means, such as rollers, to allow the frame to move along the tracks in the mast. The legs are then mounted in a pair of parallel tracks which extend along the top of the mast in its horizontal position. A horizontal bar advantageously extends between either side of the frame, thereby acting as a support in front of or behind the path of a worker to aid his balance.

Alternatively, the safety apparatus may be mounted on an “I” or “T” section beam on the mast, the mounting means being adapted to fit the width of the beam. Support wheels which rest on the surface of the beam facilitate the motion of the apparatus along the horizontal mast.

The support member is preferably made of a light-weight material, such as aluminium, steel, carbon fibre or plastic, in order that it may be transported with ease. However, the member is preferably strong enough to support the weight of an individual, in order to arrest their fall from the elevated surface in the event that the worker loses his balance.

The support member may be advantageously designed such that it will define a support barrier either side and/or behind the worker. This will therefore serve to arrest the fall of an individual in directions other than parallel to the axis of the mast. A number of designs of the support member are therefore envisaged, including a collapsible arrangement which is easy to transport.

Furthermore, the safety apparatus may advantageously be removable from the elevated surface by means of a release mechanism which preferably involves a spring-leaded clamp arrangement. The clamping mechanism may, for example, take the form of one or a pair of resilient brackets which are rotatably attached to the base of the apparatus. The brackets may be rotated to securely clamp the apparatus to the mast or to remove it from the mast. A pin is provided which allows the bracket(s) to be locked in place, or when the pin is pulled out, rotatable about the hinge. The support member can then be parked either at the top of the mast such that it would not impede normal rig operation, or it can be removed from the mast and stored on the rig base unit.

The safety apparatus is preferably provided with a brake mechanism which, in use, will serve to resist the motion of the support member in the tracks. For example, when an individual is working at a particular location along the mast, it is beneficial that the support member is secured in a desired position and will not move along the tracks in the mast.

Embodiments of the present invention are envisaged, in which the support member is provided with a point of attachment for a safety line. This may advantageously be connected to a second unit (i.e. a second safety apparatus) or to the cathead at the top of the mast to provide a secure tie off for the safety line. Furthermore, the support member may also have a means to hold, for example, tools or a toolbox.

The present invention may also be usefully employed to facilitate the reeving of the rotary head of the piling rig. This task requires threading a steel rope several times between the cathead and the rotary head. It is therefore envisaged that the sheave wheels can be mounted on the safety apparatus and the safety apparatus can then be walked along the mast between the cathead and the rotary head with the steel rope extending therebetween. Furthermore, when de-rigging the piling apparatus, the cathead sheaves can be mounted on the support member.

For a better understanding of the present invention, and to show how the same may be carried into effect, reference will now be made, by way of example, to the accompanying drawings in which:

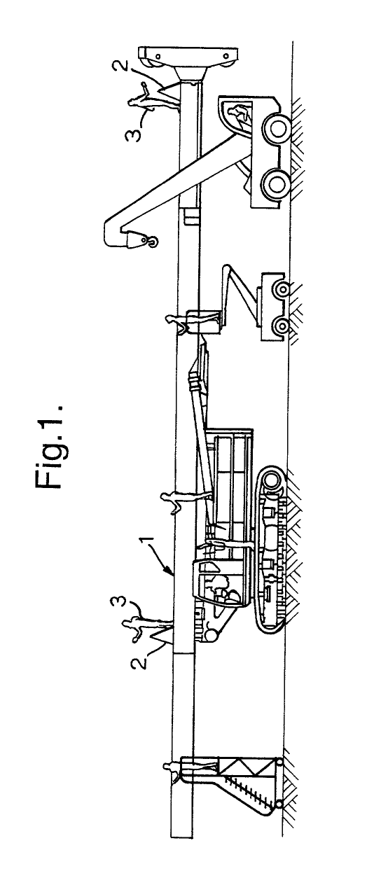

FIG. 1 represents a piling rig with its mast horizontal and shows the safety apparatus in use;

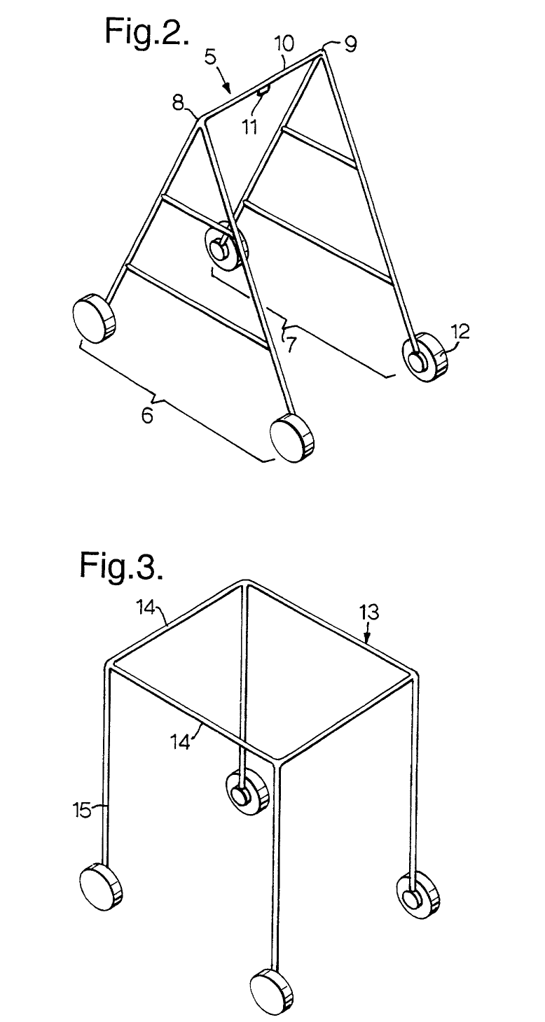

FIG. 2 shows an embodiment of the support member of the present invention; and

FIG. 3 shows a further embodiment of a support member of the present invention.

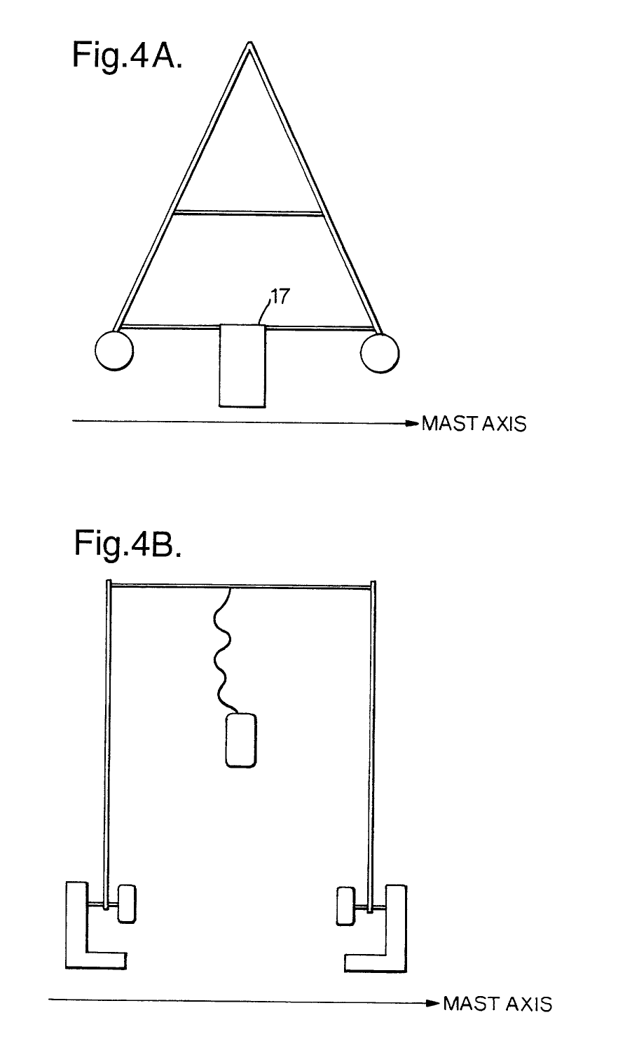

FIGS. 4A and 4B show the support frames of FIGS. 2 and 3 respectively, having a clamping mechanism;

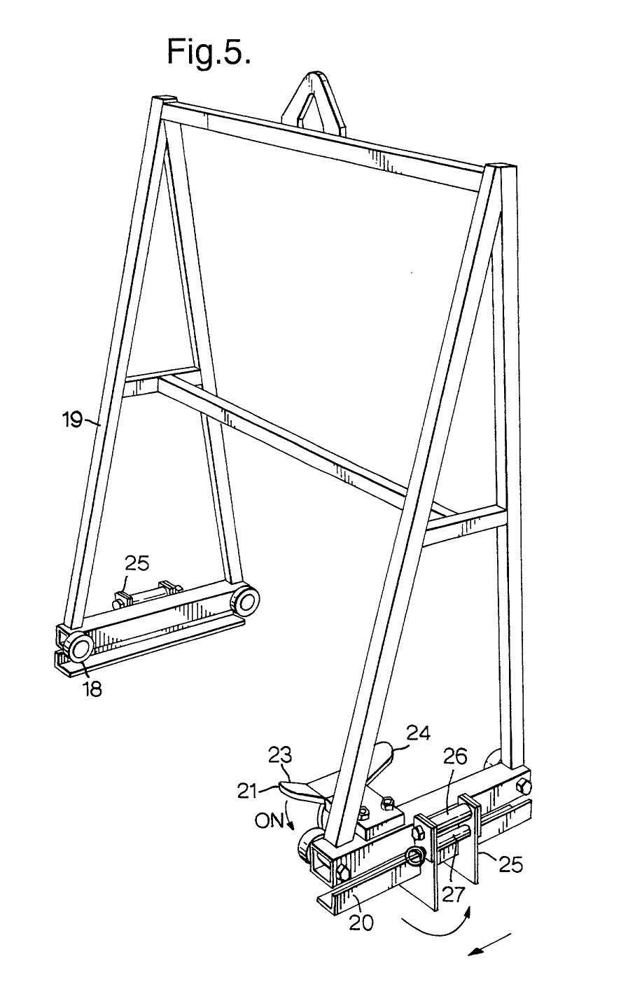

FIG. 5 shows a detailed illustration of an embodiment of the present invention;

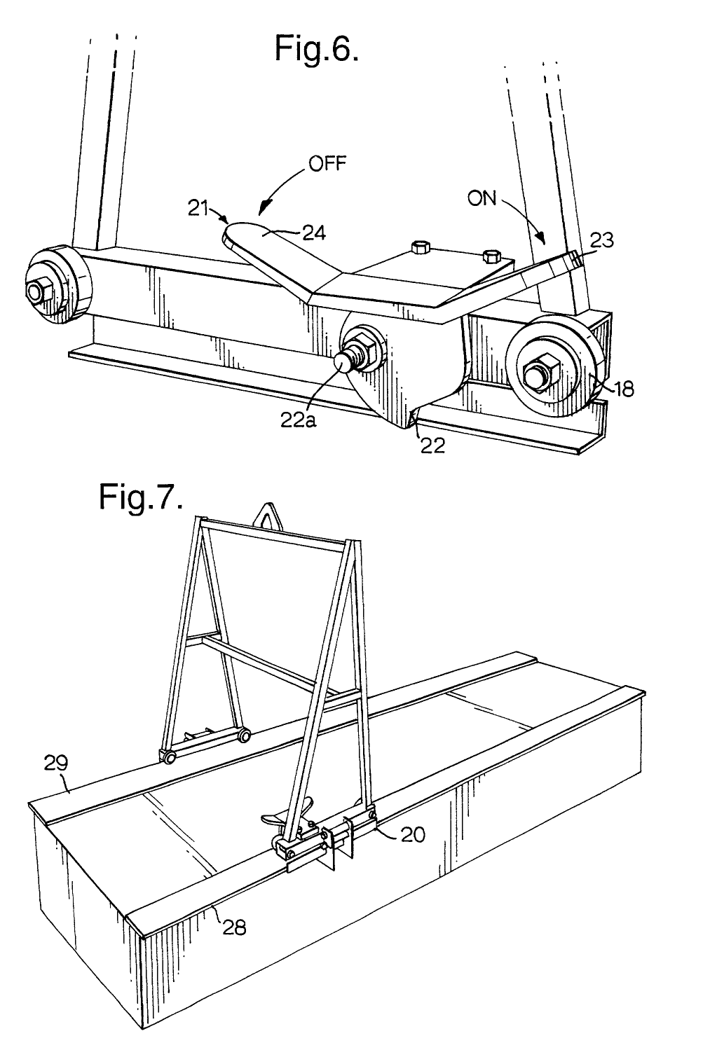

FIG. 6 shows an example of a brake-mechanism for use with the present invention;

FIG. 7 shows a safety apparatus mounted on a section of a mast;

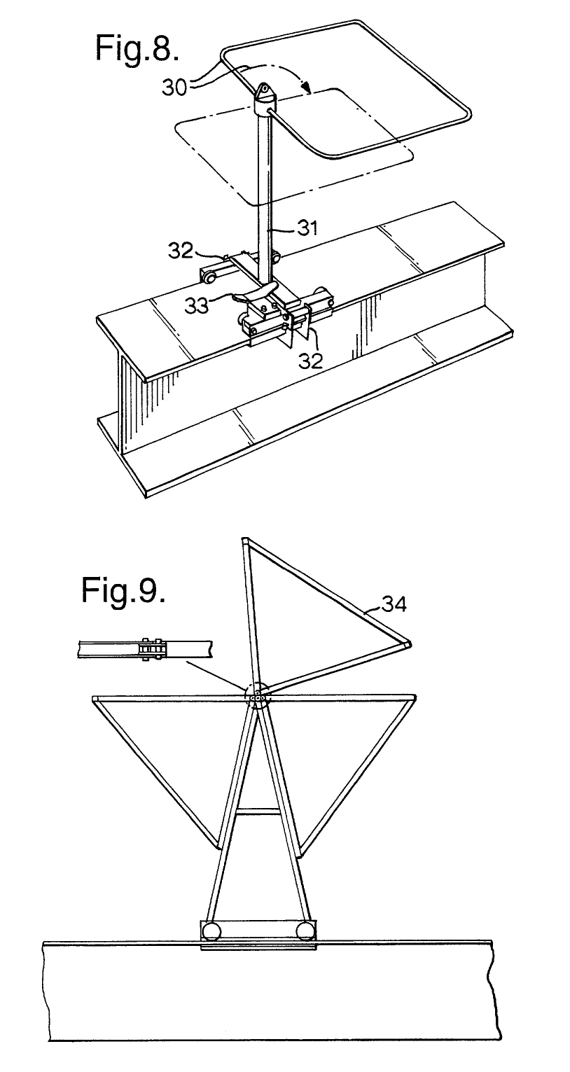

FIG. 8 shows a further embodiment of the present invention mounted on an I-beam and having a safety rail;

FIG. 9 shows a further embodiment of the present invention; and

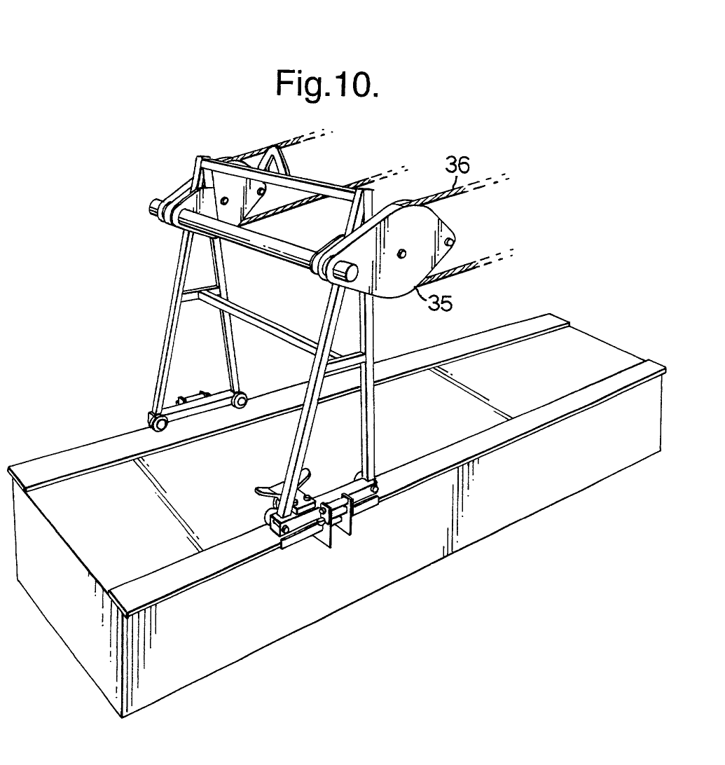

FIG. 10 shows a safety apparatus of the present invention being used to carry the cathead sheaves.

Referring to FIG. 1, this shows a piling rig with its mast 1 in a horizontal position. The Figure illustrates a typical working arrangement, including means of access to and egress from the rig. A number of individuals 3 are using a safety apparatus 2 of the present invention.

An embodiment of a safety apparatus of the present invention is shown in more detail in FIG. 2 and comprises a support frame 5, having two pairs of legs 6 and 7, wherein each pair of legs is joined at the top so as to form an apex 8 and 9. The frame is made from a light-weight material such as aluminium.

A horizontal bar 10 extends between the two apexes and, in use, extends across the path of motion of a worker, thereby providing a support to aid the balance of the worker and also serving to arrest the fall of the individual in a direction parallel to the axis of the mast. A tie off point 11 for a safety line/harness is also provided on the horizontal bar 10, and each of the legs is provided at the base thereof, with a roller 12 which is adapted to roll within the tracks of the horizontal mast, or on the surface of a section of the mast.

A safety apparatus of the present invention comprising a square or rectangular shaped frame 13 is shown in FIG. 3. In this embodiment, a horizontal bar 14 extends between the tops of each of the legs 15, so as to define a barrier either side, and to the front and behind, an individual.

FIG. 4A and 4B illustrate examples of the present invention and are shown from the side. The axis of the mast is indicated by the direction of the arrow. The frames are provided with a clamping mechanism which serve to fix the position of the support frame to the mast so as to resist the motion of the frame in the tracks. The clamping mechanism comprises an engaging member 17 which may be raised or lowered in order to release or secure the support frame to the mast.

FIG. 5 shows in more detail, an embodiment of the present invention. Four support wheels 18 are provided to allow the support member 19 to be moved along an elevated surface. The wheels may be adapted to be received in longitudinal tracks provided on the upper surface of the mast, or they may cooperate with the surface of the mast while two edge portions 20 serve to cooperate with a section of the mast.

The apparatus is provided with a brake member 21 which is shown in more detail in FIG. 6. The brake member 21 includes a flange portion 22 which is pivotable about a bolt 22a. A worker can tread on the leading portion 23 of the brake member, in order to move flange 22 away from wheel 18 thus freeing the wheel to move with respect to the mast. This will serve to allow free motion of the wheel when the worker wishes to move the apparatus to a particular location. In order to activate the brake, the worker must tread on the rear section 24 of the brake member thereby causing the flange portion 22 to engage the wheel 18 to prevent movement of the support member. In this condition, the apparatus is prevented from moving so that the worker can carry out the actions required. The brake is therefore pivoted, in use, about the axis defined by bolt 22a and allows the movement of the safety apparatus to be switched between an on-position and an off-position.

Also shown in FIG. 5 is a pair of brackets 25 which are resiliently biassed towards the outer edges of the mast or mast section. The brackets can be rotated about a pivot bar 26 when a pin 27 has been pulled out, thereby allowing the position of the brackets to be adjusted so as to secure the safety apparatus to the mast or to remove it from the mast.

FIG. 7 shows the safety apparatus illustrated in FIG. 5 when it is mounted on a section of the mast. The width of the frame is arranged to be such that the edge portions 20 cooperate with the sides of the mast section 28 and 29.

Another embodiment of the present invention is shown in FIG. 8, in which the safety apparatus further comprises a safety rail 20 which is pivotal about the top of a longitudinal stem 31. Two edge portions serve to cooperate with the top of an “I” section beam and a pair of resilient brackets 32 and a brake 33 are also provided. The pivotal attachment of the safety rail 30 allows the rail to be swung through 180°. The safety device can therefore be used by a worker on either side of the support member.

FIG. 9 shows a safety apparatus of the present invention when viewed from the side and illustrates the way in which the safety rail 34 can be rotated about the frame.

FIG. 10 shows a safety apparatus of the present invention being used to facilitate the reeving of the rotary head. The cathead sheaves 35 are mounted on the apparatus so that a worker can walk the sheaves between the rotary head and the cathead while the steel rope 36 extends therebetween.

1. A safety apparatus for use on an elevated surface, the apparatus comprising:
i) a support member which projects up from the elevated surface and serves to aid the balance of an individual on the elevated surface and/or arrest the fall of an individual from the elevated surface,
ii) a mounting arrangement which mounts the support member to the elevated surface; and
iii) an arrangement which facilitates the motion of the support member along said elevated surface.

2. A safety apparatus as claimed in claim 1, wherein said arrangement which facilitates the motion of the support member along said elevated surface comprises at least one roller.

3. A safety apparatus as claimed in claim 2, wherein the at least one roller is engageable with the interior of a track provided on the elevated surface.

4. A safety apparatus as claimed in any preceding claim, wherein said support member is provided with a point of attachment for a safety harness.

5. A safety apparatus as claimed in claim 1, 2 or 4, further comprising at least one pair of edge portions which serve to cooperate with either side of a section of the mast.

6. A safety apparatus as claimed in any preceding claim, wherein said support member comprises a frame having two sides, each side being defined by a pair of legs, wherein said frame serves to define a barrier either side and/or in front of and/or behind, an individual, to arrest the fall of the individual therepast.

7. A safety apparatus as claimed in claim 6, wherein the pairs of legs on either side of the frame are joined at the top to form an apex.

8. A safety apparatus as claimed in any preceding claim, wherein said support member is made from aluminium or steel or carbon fibre or plastic.

9. A safety apparatus as claimed in any preceding claim, further comprising a safety rail which is pivotally connected to the upper end of the support member.

10. A safety apparatus as claimed in any preceding claim further comprising a brake which is operable to resist the motion of the support member along the elevated surface.

11. A safety apparatus as claimed in any preceding claim further comprising a clamping mechanism at which is operable to secure the safety apparatus to the mast or to remove the safety apparatus from the mast.

12. A safety apparatus as claimed in claim 11, wherein said clamping mechanism comprises at least an resilient bracket.

13. A safety apparatus as claimed in any preceding claim, wherein said support member is provided with a holder which holds tools or the like.

14. A safety apparatus as claimed in any preceding claim, wherein the elevated surface is a mast in its horizontal position.

15. A safety apparatus for use on an elevated surface, the apparatus comprising:
i) a support member which projects up from the elevated surface and serves to aid the balance of an individual on the elevated surface and/or arrest the fall of an individual from the elevated surface,
ii) a mounting means for mounting the support member to the elevated surface; and
iii) a means to facilitate the motion of the support member along said elevated surface.
